(19) United States
(12) Patent Application Publication
(10) Pub. No.: US 2013/0262188 A1
(43) Pub. Date: Oct. 3, 2013

(54) SOCIAL MEDIA BRAND MANAGEMENT

(71) Applicants: David Philip Leibner, Las Vegas, NV (US); Jason Aaron Henderson, Las Vegas, NV (US)

(72) Inventors: David Philip Leibner, Las Vegas, NV (US); Jason Aaron Henderson, Las Vegas, NV (US)

(21) Appl. No.: 13/431,094

(22) Filed: Mar. 27, 2012

(51) Int. Cl. G06Q 30/02; G06Q 30/06; A63F 9/24; G06Q 10/06

(52) U.S. Cl. 705/7.36; 705/14.41; 705/26.1; 463/25

(57) ABSTRACT

A real-time social media system brand management system that provides a balanced approach to listening, posting and reporting, using an agency model for creating one or more posts, tagging the posts, committing the posts, scheduling one or more timed to submit the posts to one or more social media services; analyzing all the posts submitted for effectiveness using metrics; establishing one or more publishing strategy guidelines using the analysis; and reviewing scheduled and historical posts to drive content creation using the one or more publishing strategy guidelines.

### FIELD OF THE INVENTION

The present invention relates to the field of social media, more specifically to a system for real time social media brand management that provides a balanced approach to listening, posting and reporting.

### BACKGROUND

There are many programs for posting content to social media sites; among these are HootSuite and Radian6. Advantageously, HootSuite is an easy to use twitter application where individuals can track and maintain their posts. Disadvantageously, HootSuite cannot create rich content posts nor perform archive searches. On the other hand, Radian6 has many reporting features that can assist businesses in reviewing their social media progress. However, there is a steep learning curve and high cost for the service that makes it prohibitive for anyone but large institutional users. Also, the reports cannot be viewed in real-time. Therefore, there is a need for a real-time social media brand management system that provides a balanced approach to listening, posting and reporting.

### SUMMARY

The present invention solves the problems with the prior art by providing a method for a real-time social brand management system comprising: opening a post creation graphical user interface by a user, creating one or more posts, tagging the posts, committing the posts, scheduling one or more times to submit the posts to one or more social media services, analyzing the posts submitted for effectiveness using metrics, establishing one or more publishing strategy guidelines using the analysis, and reviewing scheduled and historical posts to drive content creation using the one or more publishing strategy guidelines. In a preferred embodiment, the post can be a suggested post or a scheduled post. The suggested post can be submitted to a suggested content list that is stored in a user account. The scheduled post can also be submitted to a schedule queue in the user's account. Additionally, the suggested content list can be reviewed to determine if the post should be archived or approved. If the post is to be archived, then the post is added to an archive queue that can be searched by category at a date to be scheduled for resubmission. Tagging posts can be done using a preset category, a user created category or a post type indicator. The user can also review content submitted to various social media sites and reply or share the reviewed content. Also, the metrics used can be a category tag.

In another embodiment, there is provided a method for a system real-time social brand management system comprising: establishing rules for one or more listening, posting and reporting games by an administrator, configuring games, where the games can be combined into contests, awards and designations, promulgating the contests, games, awards and designations, providing access to the contests, games, awards and designations for one or more contestants, measuring contestants activity and scoring the one or more contestants results, and awarding prizes, designations or both prizes and designations for activity ranked against peers. The games can comprise rules and expressions that are evaluated. One or more contestants can enter the contests and their scores are weighted for each contestant against other contestants. The winner of the contests are provided awards, where the awards can be points, vacation days, gifts, gift cards and bonuses. Designations can be provided based on the contestants accumulating awards.

Additionally, the method can comprise: inviting a second user of a second account to create a proxy account, receiving and acceptance from the second user, creating a proxy account for the second user, adding the created proxy account for the second user to a posting group, and attaching social media profiles to the created proxy account.

In another embodiment the method can comprise: selecting a posting group as the destination for a new post; submitting the new post as a suggestion, where the post is submitted to the proxy accounts suggested content list; submitting the new post as a scheduled post, where the new post is submitted to the proxy accounts scheduled queue; approving the new post by the proxy user and scheduled for submission; and submitting to a third-party social media system stored in the profile associated with the proxy account the new post. The second users are invited by email and can accept the invitation by selecting a link in the provided e-mail.

In another embodiment the method comprises: creating a post, where the post created can be a genome or a basic post; selecting a social media services profile to submit the post; submitting a non-split post to the selected social media services profiles; copying the original post genome into a customizable content area for the selected profile; modifying the copied post genome based on demographics stored in the social media services profiles and limits and special features of any selected channel; committing the post as a suggestion, where the post is submitted to the user's account suggested content list; committing the post as a scheduled post, where, the post is submitted to the users account scheduled queue; approving and scheduling the post by an administrator for submission; and submitting the profile specific content using a post service to the selected social media services at a scheduled time.

In another embodiment the method comprises: creating a post, where the post created can be a genome; shortening a uniform resource locator for insertion into the post; inserting a templated shortened uniform resource locator into the post content; selecting the social media profiles proposed for submission; committing the post as a suggestion, where the post is submitted to the user's account suggested content list for approval; committing the post as a scheduled post, where the post is submitted to the user's account scheduled queue; submitting the post using a post service to selected social media services, and replacing the templated shortened uniform resource locator with a channel indicator at a scheduled time; receiving a selection indicator from an external user on the social media service; interpreting and recording the received link as coming from the original channel; and redirecting the received link to the intended uniform resource locator containing the post.

In another embodiment there is provided a system real-time social brand management system that provides a balanced approach to listening, posting and reporting to qualify and reward user activity comprising the steps of: configuring games, where the games can comprise rules, contests and awards for gamification; performing activities; determining if activity processing is to be automatic; manually accessing gamification results; manually executing a contest component; manually executing an award component; displaying awards and achievement results to a user accessing the system; automatically executing a gamification service on a predefined schedule; automatically executing a contest component on a predefined schedule; and automatically executing an award component on a predefined schedule. Contest summary, award and achievement notice e-mails are sent to all contestants when the respective component is executed.

In another embodiment there is provided a method for a system real-time social brand management system comprising the steps of: determining one or more than one social media engagement strategy by posting, listening and connecting with social media users; configuring the social media engagement strategy by an administrator; evaluating the social media users activities against the activities adherence to the defined social media engagement strategy, where the evaluation is calculated using scores, posts, scheduled activities and established rules as criteria; and providing suggested activities to assist the social media user in adhering to the social media strategy. The method further comprises: performing activities by a user; executing a strategy analysis component against a scheduled activity that is relevant to the activity being performed; scoring the scheduled activity; and providing new activities for the user to perform.

There is also provided a method for a real-time social brand management system comprising: providing a post calendar; configuring a strategy containing a directive indicating the percentage of activities by an administrator; performing the activity configured by the administrator; opening the post calendar; executing a strategy analysis component when the post calendar is opened; evaluating the post activity using a criteria to ascertain if the user is and adherence with the directive configured by the administrator; and displaying a notification to the user identifying post categories that would improve the strategy score for the user.

In yet another embodiment there is provided a method for a system real-time social brand management system to qualify and reward user activity comprising: providing a content store where the content store comprises: subscriber account information; issue information; subscription information; issue delivery information; publisher account information; and product information, providing subscription purchase options for one or more pieces of content at a price set a content publishers that provides content; billing for purchased subscriptions; delivering purchased subscriptions. Purchase subscriptions are delivered at one or more time periods stored in the content store. The subscriber accounts provide publisher accounts with proxy rights to social media profiles so that the publisher account can deliver suggested content to the subscriber account. The accounts can be delivered as a split post to one or more supported social media profiles. The products information comprises storing a subscription period, a price per suggestion and a price per post that is stored in one or more social media profile supported by the content.

In a related embodiment, the method also comprises: providing instructions for a configuration module; providing instructions for a services module; providing instructions for a content store; and providing instructions for a publisher dashboard. The instructions for the configuration module further comprise instructions for: a product setup module; an issue setup module; and a content store administration module. The instructions for the services module further comprise instructions for: an automated issue delivery service; and an automated billing service.

In another preferred embodiment there is provided a real-time social brand management system that provides a balanced approach to listening, posting and reporting comprising: a non-transitory computer readable storage medium comprising executable instructions to configure a computer to perform a method comprising the steps of: opening a post creation graphical user interface by a user; creating one or more posts; tagging the posts; committing the posts; scheduling one or more timed to submit the posts to one or more social media services; analyzing all the posts submitted for effectiveness using metrics; establishing one or more publishing strategy guidelines using the analysis; and reviewing scheduled and historical posts to drive content creation using the one or more publishing strategy guidelines. The system further comprises instructions for a configuration module for configuring the system; a game setup module operably connected to the configuration module; a contest setup module operably connected to the configuration module; a rules setup module operably connected to the configuration module; an award setup module operably connected to the configuration module; a designation set up mode operably connected to the configuration module; a services module operably connected to the configuration module, where the services module comprises instruction for a contest service module and an award service module; an award fulfillment module operably connected to the configuration module; a leaderboard operably connected to the configuration module; an account information store operably connected to the configuration module, where the instructions for the account information store comprise account information and one or more than one social media profile and one or more than one user associated with the account. The information for each user associated with the account has unique credentials to access the system and for tracking. The system further comprises computer instructions for configuring a proxy account and a non-proxy account, where the proxy account comprises one or more than one different social media profiles than the non-proxy account.

### BRIEF DESCRIPTION OF THE DRAWINGS

These and other features, aspects and advantages of the present invention will become better understood with regard to the following description, appended claims, and accompanying figures where:

FIG. 1 is a flowchart diagram of a system real-time social brand management system that provides a balanced approach to listening, posting and reporting according to one embodiment;

FIG. 2 is a is a detailed flowchart diagram some steps of a method used to qualify and reward user activity in the system of FIG. 1;

FIG. 3 is a diagram of a system for performing the steps of the method of FIG. 2;

FIG. 4 is a workflow diagram of the system of FIG. 3;

FIG. 5 are screenshots of a user interface useful for the system of FIG. 2;

FIG. 6 is an entity diagram for a user of the system of FIG. 2;

FIG. 7 is an entity diagram of a proxy configuration of the system of FIG. 2;

FIGS. 8a and 8b are a workflow diagram of some steps of a method for using the proxy configuration of FIG. 7;

FIG. 9 is a workflow diagram for split posting of social media content for the system of FIG. 2;

FIG. 10 is a workflow diagram for tracking channel specific uniform resource locators for the system of FIG. 2;

FIG. 11 is a workflow diagram for gamification for the system of FIG. 2;

FIG. 12 is an entity state diagram for social process guidance useful for the system of FIG. 2;

FIG. 13 is a work flow diagram for social process guidance for the system of FIG. 12;

FIG. 14 is a work flow diagram for a post calendar useful for the system of FIG. 2;

FIG. 15 is an entity diagram of a content store useful for the system of FIG. 2;

FIG. 16 is a diagram of a content store system useful for the system of FIG. 2; and

FIG. 17 is a workflow diagram of the content store system of FIG. 16.

### DETAILED DESCRIPTION

The present invention overcomes the limitations of the prior art by providing a real-time social media brand management system that provides a balanced approach to listening, posting and reporting. As can be appreciated, the currently available social media systems provide a variety of services and capabilities that are at best inconsistent and have grown from small individual applications into larger more complex applications without the benefit of starting with a singular vision. Additionally, the vast majority of these systems have been built for individuals to use and not specifically for businesses, or business purposes. With the advent of social media there are new avenues available for businesses to market their goods and services to anyone with an Internet connection, a phone, or a tablet computer. Also most of the systems do not provide ways for multiple users to use a single account where their activities on the single account can be tracked, monitored and encouraged. The present invention solves these problems and many more.

Methods and devices that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the Figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific detail. Well-known circuits, structures and techniques may not be shown in detail in order not to obscure the embodiments. For example, circuits may be shown in block diagrams in order not to obscure the embodiments in unnecessary detail.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage may represent one or more devices for storing data, including read-only memory (ROM), random access memory (RAM), magnetic disk storage mediums, optical storage mediums, flash memory devices and/or other machine readable mediums for storing information. The term “machine readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, or a combination thereof. When implemented in software, firmware, middleware or microcode, the program code or code segments to perform the necessary tasks may be stored in a machine-readable medium such as a storage medium or other storage(s). One or more than one processor may perform the necessary tasks in series, concurrently, distributed or in parallel. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted through a suitable means including memory sharing, message passing, token passing, network transmission, etc.

In the following description, certain terminology is used to describe certain features of one or more embodiments of the invention.

The term “gamification” refers to using game design techniques and mechanics to enhance non-game hardware, software, processes or applications in order to encourage people to adopt them.

The term “post” refers to a writing that is sent to an internet site and is viewable by people other than the drafter of the writing.

The term “activities” refers to listening, posting, suggesting content, suggesting responses, analyzing results, and administration of content and social media strategies.

The term “listening” refers to reviewing online social media content for applicability to a social media branding directive or strategy.

The term “posting” refers to submitting content to one or more social media services, such as, for example, “tweeting”, submitting a comment to a blog article, submitting a blog article, writing on a Facebook wall, etc.

The term “tagging” refers to assigning a non-hierarchical metadata keyword or term to a piece of information, such as, for example, an Internet bookmark, digital image, post, or file, to help describe the information and allow it to be found again by browsing or searching.

Various embodiments for a real-time social media brand management system that provides a balanced approach to listening, posting and reporting according are disclosed. The system and methods will now be disclosed in detail.

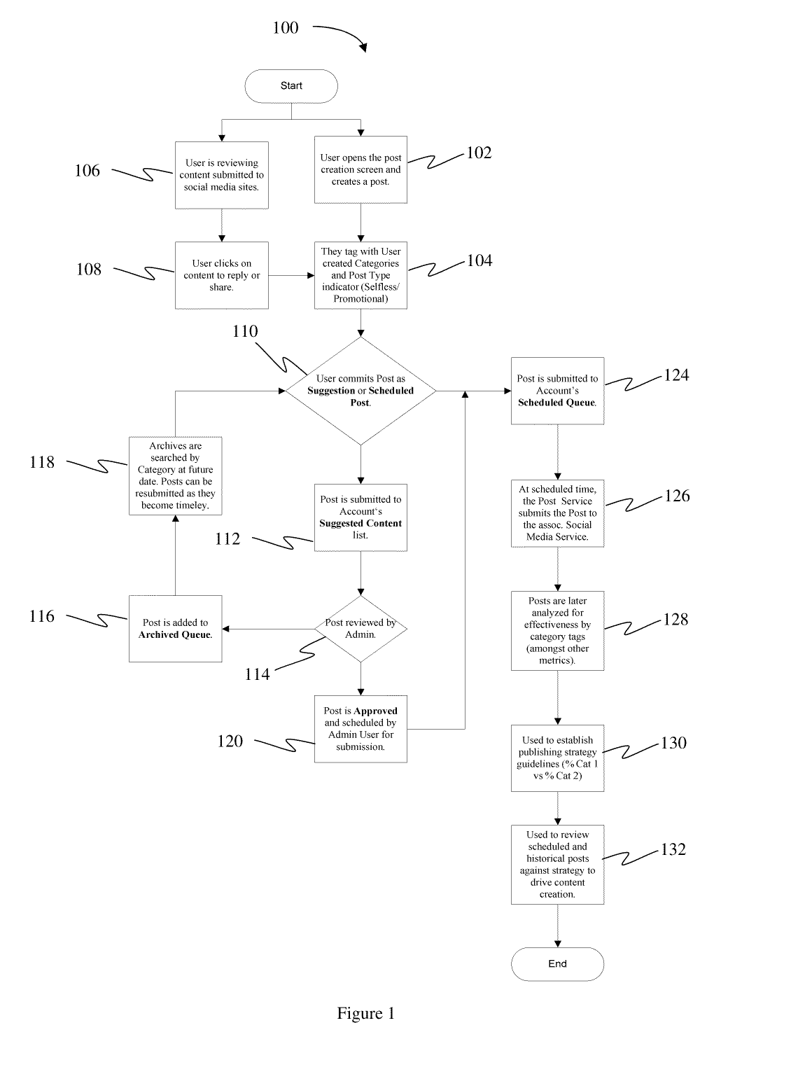

Referring now to FIG. 1, there is shown a flowchart diagram 100 of a system real-time social brand management system that provides a balanced approach to listening, posting and reporting according to one embodiment. As can be seen, a user can begin with one of 2 options. The user can open the post creation screen 102 and create a post. Then, the user can tag the post with either preset categories or user created categories and post type indicators 104. Alternatively, the user can review content submitted to various social media sites 106. Then, the user can click on the content to reply or share the content 108. Next, the user can commit the post from either of the previous steps as a suggestion or as a scheduled post 110.

If the user creates a suggestion, then the post is submitted to a suggested content list 112 in the user's account. Next, the suggested content is reviewed by an administrator 114, to determine if the post should be archived or approved. If the post is to be archived, then it is added to an archive queue 116. Then, the archive is searched by category at a later date for resubmission 118.

If the user creates a scheduled post, then the post is submitted a scheduled queue in the user's account 124. Next, the time scheduled by the user, the post service submits the post to one or more social media services 126. Then, all the posts submitted by the user are analyzed for effectiveness using various metrics 128, such as for example, category tags. Next, the analysis is used to establish one or more publishing strategy guidelines 130. Finally, the one or more publishing strategy guidelines are used to review scheduled and historical posts to drive content creation 132.

The system 100 provides the user account settings for setting system preferences to their desired social media management strategy. An example of this strategy is the 1, 2, 3 strategy:

1) promotional post;

2) selfless post; and

3) engagements (replies, re-tweets or Facebook/blog comments)

Now when the user logs into the system and accesses the post calendar, all the scheduled posts for the selected time (today, this week, this month, etc.) are displayed. The system 100 automatically identifies missing content and provides suggested posts to fill the gaps. The user can accept the suggested posts or browse the content store and purchase content to fill the gaps. This provides the user a powerful, quick and efficient way to provide new content in real-time. Additionally, the system 100 provides the capability for the user to set limits so that the user gets a warning if they exceed any set ranges or preferences, such as, for example a monthly budget for content purchase. Also, the user can set system preferences for any type of interaction, post type and category.

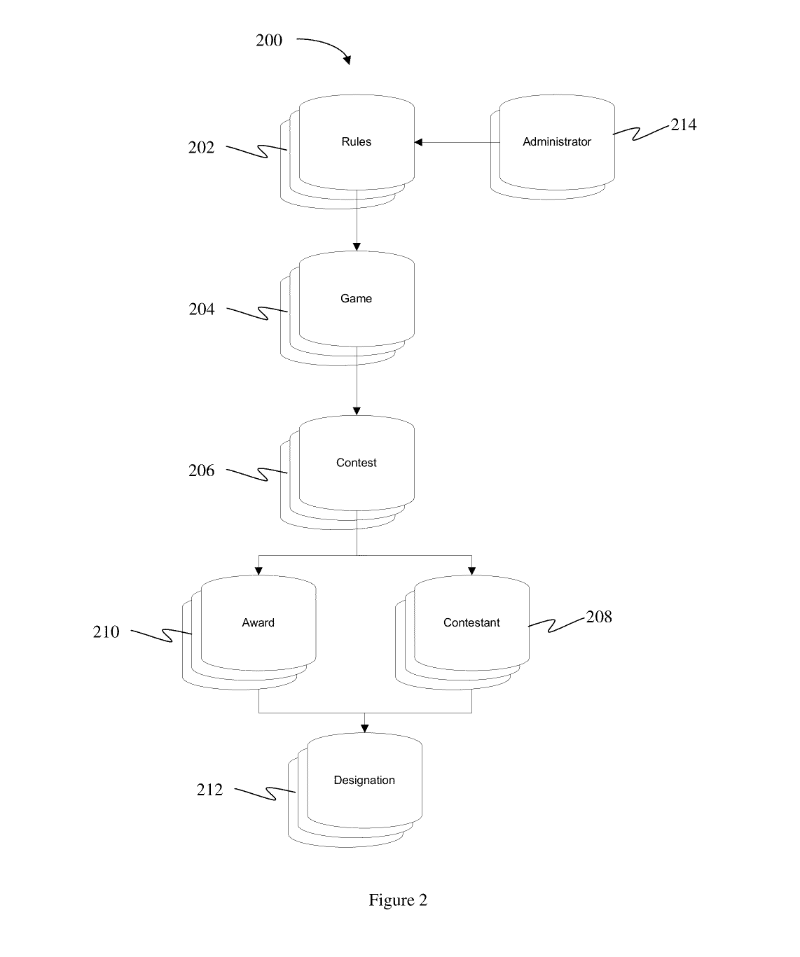

Referring now to FIG. 2, there is shown a detailed flowchart diagram 200 of some steps of a method used to qualify and reward user activity in the system of FIG. 1. As can be seen, the system 100 uses gamification to quantify and reward user activity in the system 100 to inspire more productive behavior and superior results by measuring activity and awarding prizes and designations activity ranked against peers. First, rules are established 202 for one or more games 204 established by one or more administrators 214. The game administrator 214 configures the contests, games, awards and designations that the system 100 will follow. The games can have multiple rules and expressions that are evaluated. Based on the type of rule a number will be returned to be added to a score or alternatively, a true/false for pass/fail can also be returned. Once the rules of been established 202, then the game is promulgated throughout the agency 204 to be played in accordance with the rules 202. Each of the games 204, can exist in one or more contests 206. Additionally, there can be multiple games 204 for each contest 206. One or more contestants 208 can enter one or more contests 206 and the game scores for each contestant 208 will be weighted against other contestants 208. Also, awards can be provided 210 for each contest 206. Each award is defined by an administrator 214 and each contest will provide details on the award for a particular contest 206, how it will be won, and what ranking is required. Awards may be points or other non-system items such as, for example, vacation days, gifts, gift cards, bonuses, etc. Designations are provided 212—based on contestants 208 accumulating awards from contests 206 and games 204. Administrators 214 configure designations 212 and assign award types and levels needed.

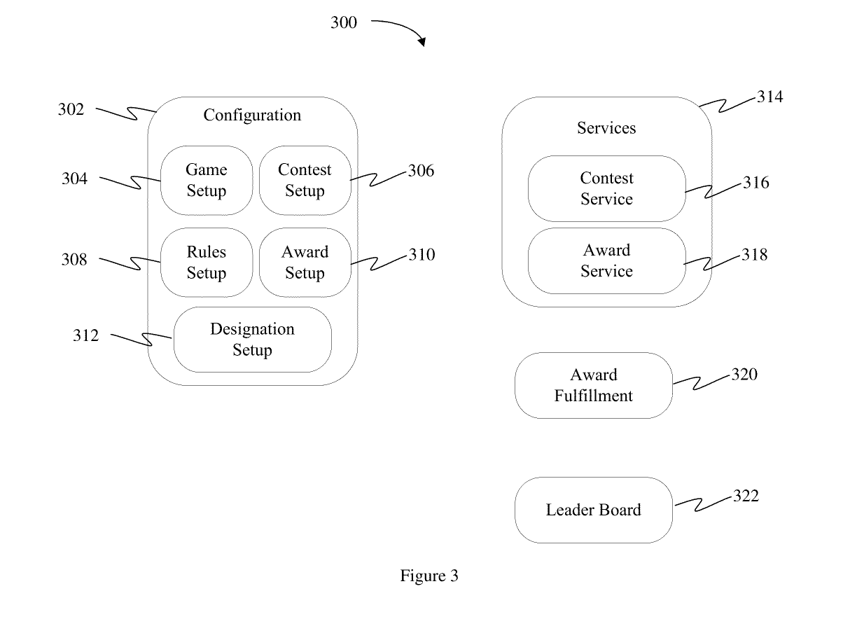

Referring now to FIG. 3, there is shown a diagram of a system 300 for performing the steps of the method of FIG. 2. The system 300 comprises a non-transitory computer readable storage medium comprising executable instructions to configure a computer to perform the method described in FIG. 2. As can be seen, the system 300 comprises instructions for configuring 302 the system. The instructions for configuring 302 further comprises a game setup module 304, a contest setup module 306, a rules setup module 308, and award setup module 310, and a designation set up 312. In addition, the system 300 has instructions for providing automated services 314 the run contests by playing games and executing rules using data points and contest parameters. The services 314 comprise a contests service 316 and an award service 318. The services 314 distribute awards and achieve designations. Also, system 300 comprises instructions for award fulfillment 320. An administrator 214 can manage award fulfillment manually for awards that are outside the scope of the system 300, such as, for example, vacation days. Additionally, the system 300 provides instructions to post a leaderboard 322 that is viewable by the contestants 208 so that each contestant 208 can see the performance relative to other contestants 208 across each game 204 or contest 206.

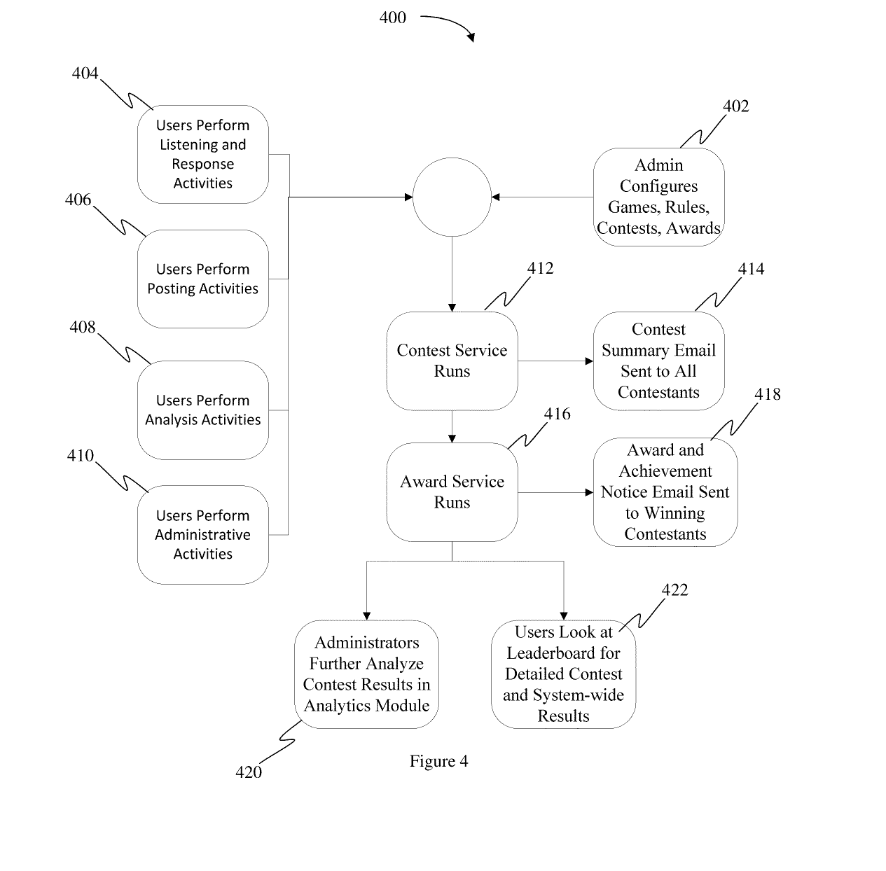

Referring now to FIG. 4, there is shown a workflow diagram 400 of the system of FIG. 3. As can be seen in this workflow diagram 400, an administrator 402 configures the games 204, rules 202, contests 206 and awards 210. Users 404, 406, 408 and 410 perform listening activities on one or more than one social media site. The contests service 412 runs using the configurations set up by the administrator 402. A contests summary communication can be sent to all contestants 414. Additionally, an award service 416 is operable during the contests. The award service 416 provides award and achievement notices to the winning contestants 418. Administrators can further analyze contest results in the provided analytics module 420. Finally, contestants can review a leaderboard for detailed contest and game results 422.

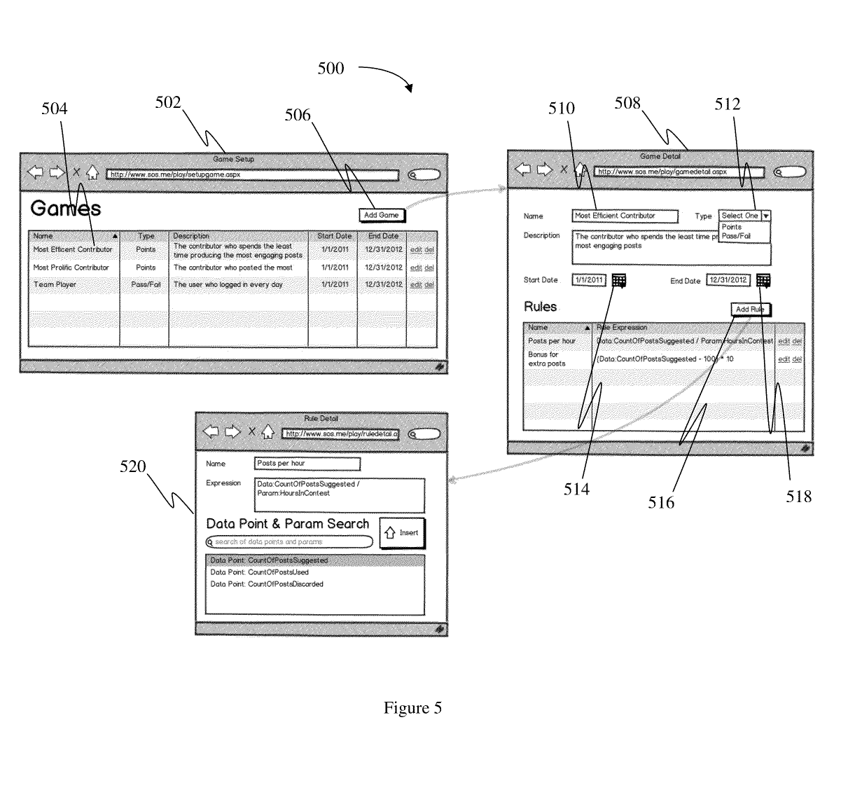

Referring now to FIG. 5, there is shown screenshots 500 of a user interface useful for the system of FIG. 2. As can be seen, a graphical user interface is provided to set up a game 502 by one or more than one administrators. The administrator is provided a list of currently available games 504. The administrator can add additional games by selecting the add game button 506. A new game detail dialog box 508 is shown to the administrator. The administrator adds details and rules for the game such as a game name 510 a game description 512 start date 514 and end dates 516. One or more than one rule can be added to the game by selecting the add rule button 518 on the game detail dialog box 508. A new rule detail box 520 is shown to the administrator, where the addition of rules for the game can be added.

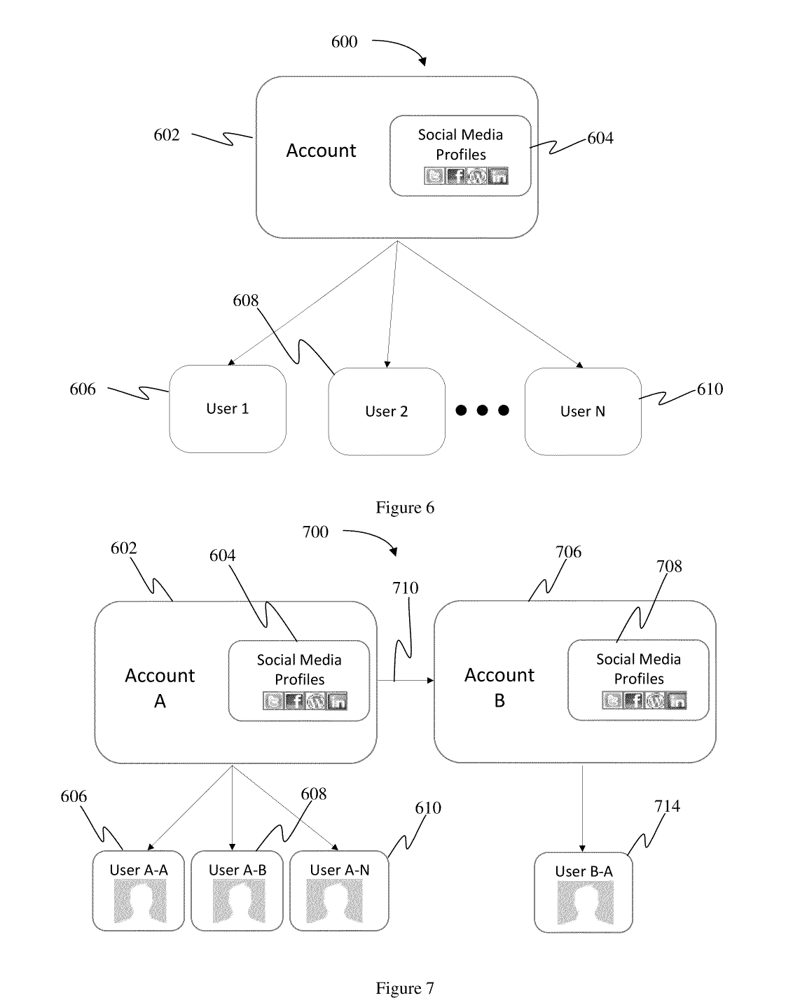

Referring now to FIG. 6, there is shown an entity diagram 600 for a user of the system of FIG. 2. As can be seen, each entity 600 comprises an account 602, and one or more than one social media profile 604. The account 602 comprises a single identity or brand for an individual, company or organization. The one or more than one social media profile 604 comprises the social media accounts and application program interface for the social media account connected with the account 602. Each account 602 can have one or more than one user 606, 608 and 610 associated with the account 602. Each of the one or more than one user's 606-610 have individual credentials to access the system and for tracking purposes.

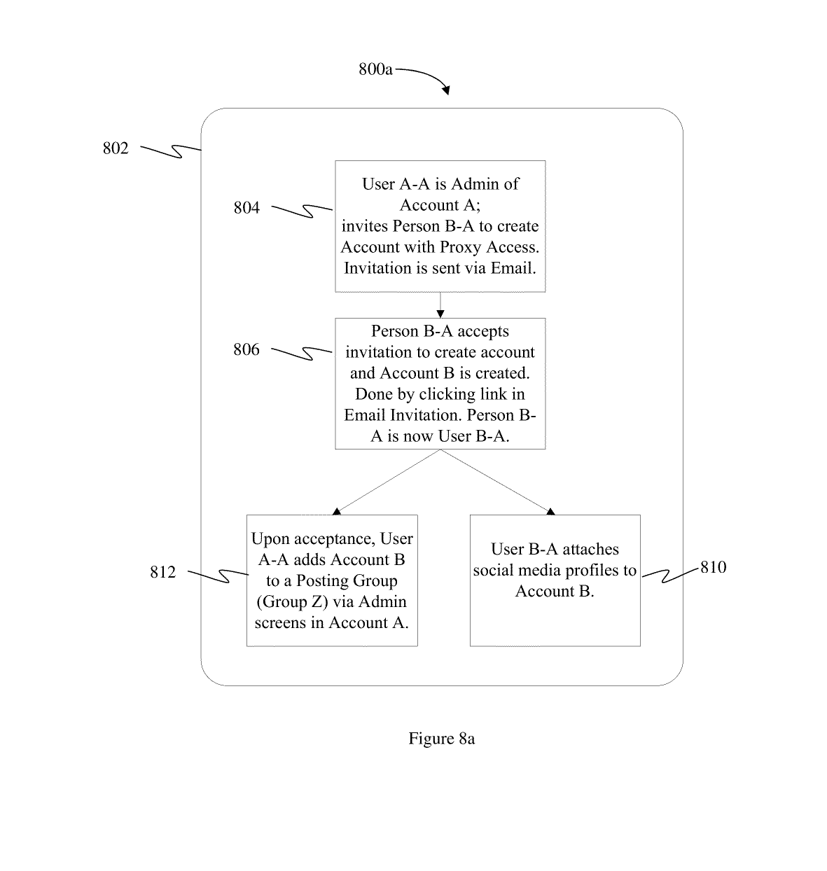

Referring now to FIG. 7, there is shown an entity diagram 700 of a proxy configuration of the system of FIG. 2. As can be seen, in this configuration, two separate accounts 602 and 706 can be configured in a proxy relationship 710. The proxy account 706 can comprise one or more than one different social media profiles 708 than the non-proxy account 602. Additionally, the proxy account 706 can comprise different users 714 than the non-proxy account 602. In this configuration, users 606-610 can access the proxy account 706 for posting and reporting on the different social media profiles 708. This process allows a larger agency relationship than is possible with currently available tools.

The system 200 provides a parent child relationship with a parent can activate children to suggest content in real-time up to the parent to be approved, edited, denied or archived. This ability bridges the gap between administrators and contributors and provides the ability to share the responsibility for activities related to the brand without the liability. This is analogous to a television director in a control room at a football game controlling how multiple cameramen on the field shoot video of the game while the director controls what content goes out for viewing by the public. The proxy functionality 700 is the reverse of a content management system. The capability for the parent to push content down to the child proxies as either suggestions or scheduled activities according to an agreed-upon relationship between the two allows the parent greater control and diversity for social media brand management.

For example, if a parent company has 717 offices below them (children), utilizing the system 200 the parent can now create groups of children or individuals that can be controlled by one or more administrators. Administrators have complete control over organizing proxy groups according to a preferred strategy. The parent social media manager or administrator can push content down to all 717 children in one push to consolidate marketing and branding efforts and provide content creation from the top down. The parents will be able to track the results of these pushed down posts for each proxy and coordinate those results with the desired strategy. The parent organization can also monitor each of the proxies to determine who is performing the activities or who is not performing activities I region, by state, by gender or any other identifiers provided by the proxy relationship.

If any of the 717 children have individuals that work underneath them, the children can effectively become secondary parents to the individuals below them. The secondary parents can control access from the original parent and the individuals. The secondary parents can create new content, take suggested content sent to them from the original parent and pushed that content down to the individual children below them. Additionally, the secondary parents have all the same tracking and analytics that the original parent is provided.

As can be appreciated by those with skill in the art with reference to this disclosure, additional parent-child relationships can be created being limited only by the available computing resources.

In another example, a nightclub, the parent, has 250 employees. The nightclub has realized to tracking the promotional post about upcoming events have better results driving community growth and revenue from personal profiles of people than from the parent company itself. The nightclub uses the proxy functionality to push posts to their 250 employees (proxies) for them to approve or deny from the dashboard, a smart phone or by e-mail. The nightclub can internally track which employees posted, which proxies provided the greatest results in which content and posting time provided the greatest return.

In a further example, an individual or a business can create content for a variety of different businesses or entities for a fee. Additionally, these for pay content creators can be provided suggestions for activities by the people that employ them. These paper content creators can become proxies for the individuals or businesses that hire them to provide content or activities for their employers while remaining anonymous. The employers can then track the effectiveness of each for pay content creator to determine the best value for their business.

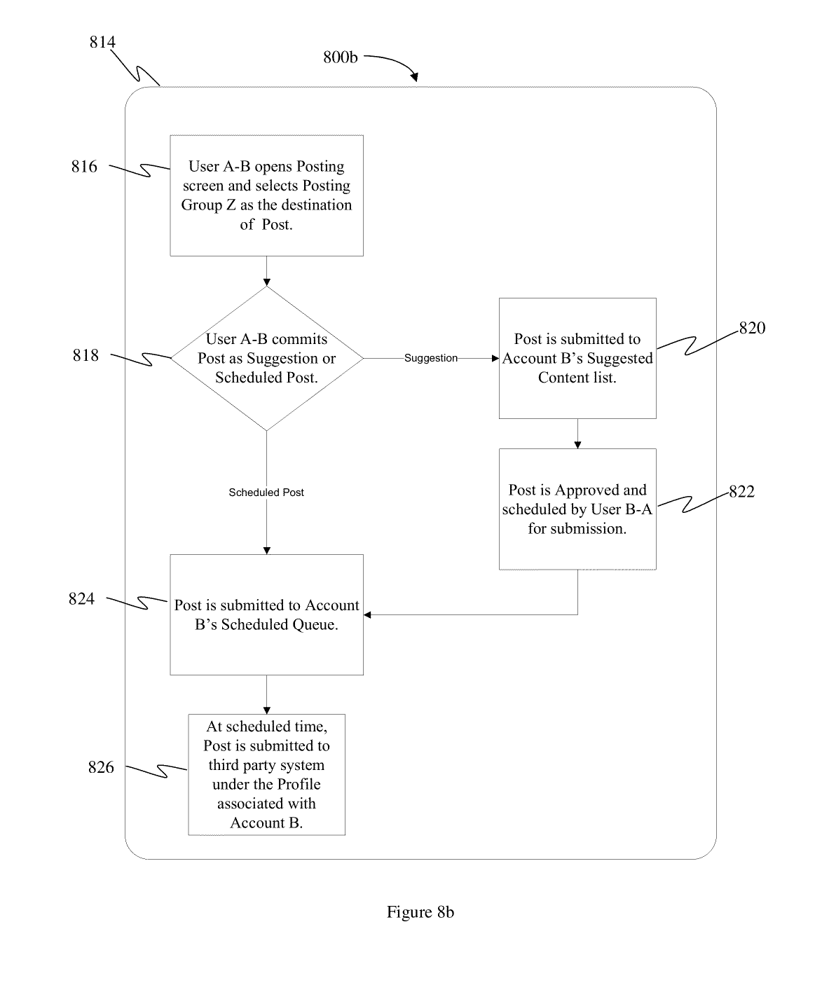

Referring now to FIGS. 8a and 8b, there is shown workflow diagrams 800a and 800b of some steps of a method for using the proxy configuration of FIG. 7. First, an administrator of a first account invites 804 a second user of a second account to create a proxy account with proxy access. This invitation is usually sent by e-mail, but as will be understood by those with skill in the art, other methods of invitations and communications can be used. Then, the second user accepts the invitation in 806 and a proxy account for the second user is created. In one embodiment the account creation is performed by selecting a link in a provided e-mail. Next, the administrator adds the proxy account for the second user to a posting group 810. As will be understood in this embodiment this action is performed using a graphical user interface provided to the administrator. Finally, the second user attaches social media profiles to their proxy account 812.

Once the proxy account has been set up to 802, the second user of the proxy account is now permitted access to the posting group 810. A non-proxy user opens a posting screen 816 and selects a posting group as the destination for a new post. The non-proxy user submits the post 818 as a suggestion or a scheduled post. If the post is a suggested post, the post is submitted 820 to the proxy accounts suggested content list. Then, the post is approved 822 by the proxy user and scheduled for submission. If the post is a scheduled post, then the post is submitted to the proxy accounts scheduled queue 824. Finally at a scheduled time, the post is submitted 826 to a third-party social media system stored in the profile associated with the proxy account.

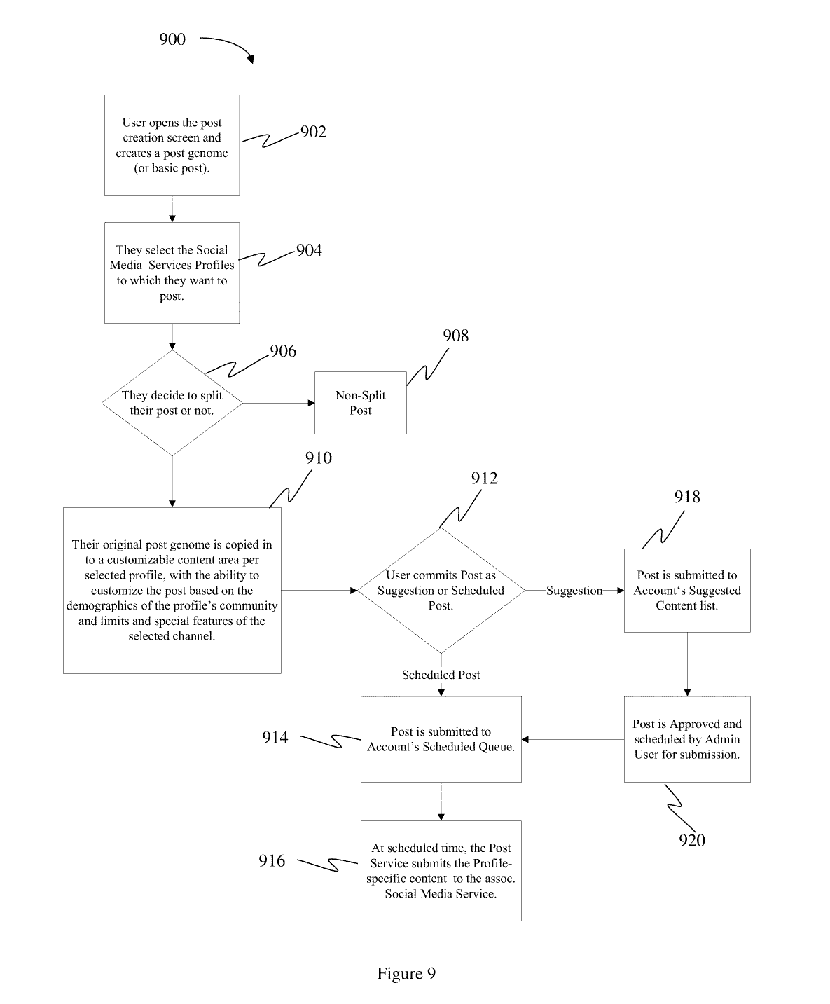

Referring now to FIG. 9, there is shown a workflow diagram 900 for split posting of social media content useful in the system of FIG. 2. First, a user creates a post 902. Optionally, the post created can be a genome or a basic post. Next, the user selects the social media services profiles 904 to submit the post. If the user chooses not to split the post 906, then the post is submitted to the selected social media services profiles 904. If the user chooses to split the post 906, then the original post genome is copied 910 into a customizable content area for the selected profile. Next, the copied post genome 910 is modified by the system for users 404, 406, 408 and 410 based on demographics stored in the social media services profiles 904 and limits and special features of any selected channel. Then, the user can commit the post as a suggestion or a scheduled post 912. If the post is a suggested post, then the post is submitted to the user's account suggested content list 918. Next, the post is approved 920 and scheduled by an administrator for submission. If the post is a scheduled post, then the post is submitted to the users account scheduled queue 914. Finally, at a scheduled time, a post service submits the profile specific content to the social media services selected earlier 916.

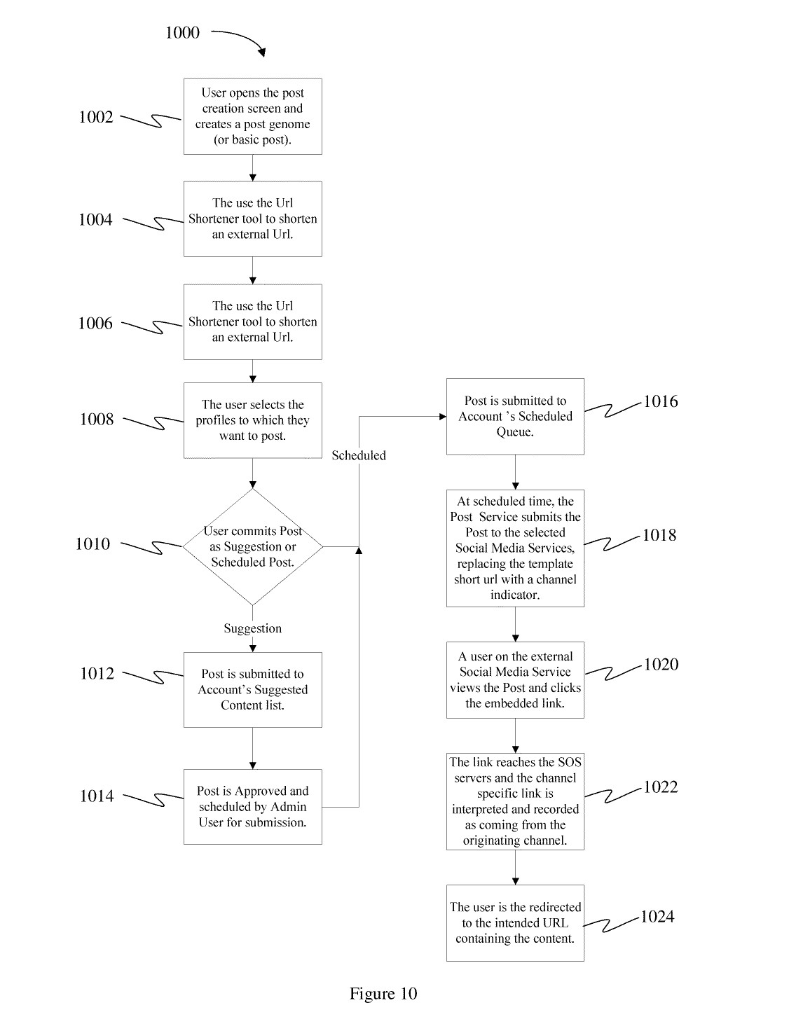

Referring now to FIG. 10, there is shown a workflow diagram 1000 for tracking channel specific uniform resource locators useful in the system of FIG. 2. First, a user creates a post 1002. Optionally, the user can create a post genome or a basic post. Next, a uniform resource locator is shortened for insertion into the post 1004. Then, a templated shortened uniform resource locator is inserted into the content of the post 1006. Next, the user selects the social media profiles proposed submission 1008. Then, the user commits the post as a suggestion or a scheduled post 1010. If the user commits the post 1010 as a suggestion, then the post is submitted to the user's account suggested content list 1012. Next, the post is approved and scheduled 1014 by an administrator for submission. If the user commits the post as a scheduled post 1010, the post is submitted to the user's account scheduled queue 1016. Next, at a scheduled time, a post service submits the post to the selected social media services 1018, and replaces the templated shortened uniform resource locator with a channel indicator. Then, a selection indicator from an external user on the social media service that has selected the embedded link is received by the system 1020. Next, the received link is interpreted and recorded 1022 as coming from the original channel. Finally, the system 1000 redirects the received link to the intended uniform resource locator containing the post 1024.

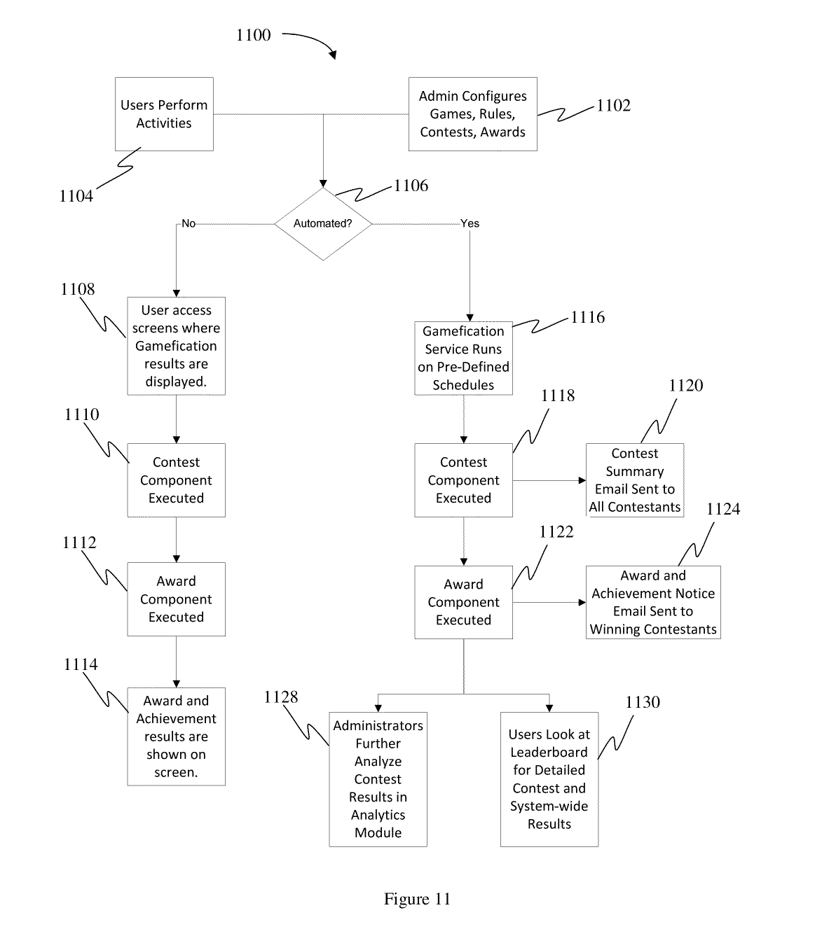

Referring now to FIG. 11, there is shown a workflow diagram 1100 for gamification for the system 200. First, an administrator configures games rules contests and awards for gamification 1102 of the system 200. Then, a user performs activities 1104 in the system 200. Next, a determination is made whether or not the process is automatic or manual 1106. If the system is manual, then, the user accesses screens where gamification results are displayed. Next, a contest component is executed 1110 by the system 200. Then, and award component is executed 1112 by the system 200. Finally, awards achievement results are displayed 1114 for the user accessing the system 200. If, however, the determination is made 1106 that this is an automated task, then a gamification service 1116, a contest component 1118 and an award component 1122 all run on a predefined schedule in the system 200. When the contest component 1118 is executed, contest summary e-mails are sent to all contestants 1120. Also, when the award component 1122 is executed, award and achievement notices are sent by e-mail to winning contestants 1124. Additionally, administrators can further analyze contest results in an analytic module 1128 provided in the system 200. Users can look at a leader board 1130 for detailed contest and system wide results.

For example, a casino may have 13 different properties with 13 different sets of social media channel specific to each one of the properties. Creating a relationship between people on the ground at each property and the corporate social media manager can be an overwhelming task. The casino, as a parent, can give the people on the ground (children) the ability to share content with the social media manager with no liability. However, there was no incentive for the children to actually share content with social media manager. Using the gamification described herein the casino can incentivize their employees (children) with rewards for providing social media content. The system 200 provides the gamification capabilities and analytics so that the casino can create multiple games and place all of them together to form a contest. This provides the casino social media manager with more relevant content for each one of the particular properties that can be posted on both the parent website and the child website.

For example, the casino social media manager desires to incentivize employees of the single property that are participating in a contributor program that rewards employees for contributing real-time content that helps the parent company accomplish it social media strategy goals. The casino social media manager selects specific rules and goals that they want their employees/contributors to perform and assigns rewards for each game. Rules for the game can be, for example:
Every contributor that suggests 20 pieces of content receives two points.
Every contributor that has 50% of their suggestions approved receives five points.
Every contributor that has 75% of their suggestions approved its 10 points.
Every contributor that has a post approved that gets over 10 likes and one share on Facebook gets five points.

The casino soul patrol media manager sets the actions to be accomplished and the results required to receive the reward and what the reward is. Now the social media manager can assign awards for various levels of success or winners, depending on the games and the contests. For example, any employee that scores 20 points in a month gets to show tickets by room and breakfast in bed. The gamification portion of the system provides the capability to motivate team members, clients or customers to submit, quantify and track content. Additionally, the employees, clients or customers are able to transparently check the leader board to see where they stand, which can further incentivize them to post more content according to the rules. Updates can also be sent via e-mail, text messages or any other form of communication as will be understood by those with skill in the art with reference to this disclosure.

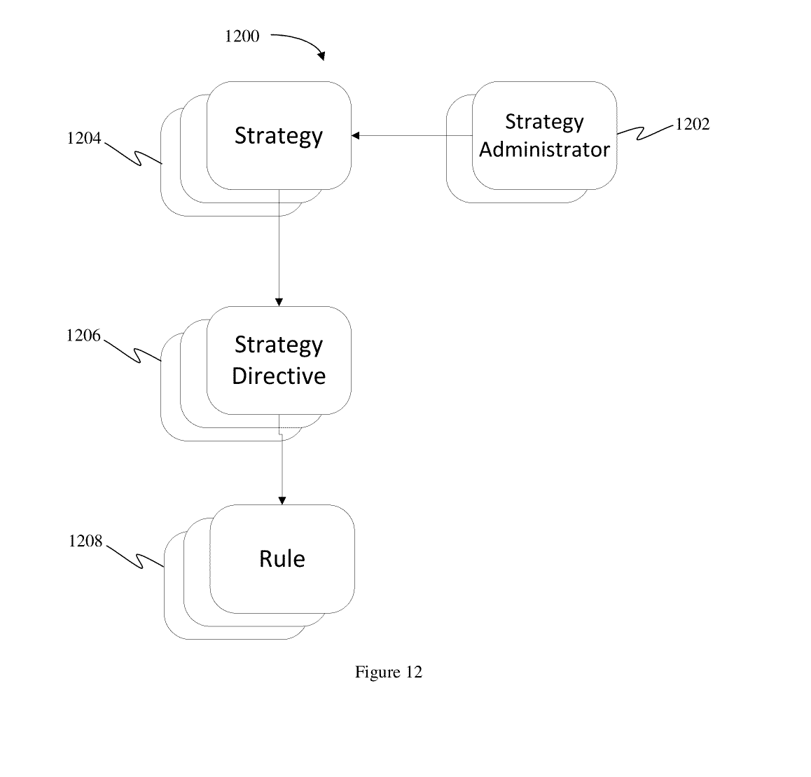

Referring now to FIG. 12, there is shown an entity state diagram for social process guidance 1200 useful for the system of FIG. 2. Social process guidance 1200 is a social media engagement strategy 1204 that is determine by posting, listening and connecting with other social media users. The social media engagement strategy 1204, is configured in the system by an administrator 1202. As users perform activities in the system 200, the social process guidance system 1200 evaluates and scores past and scheduled activities against the activities adherence to the defined social media engagement strategy 1204 and established rules 1208. Additionally, as users use features of the system 200, such as, for example, creating posts, listening, etc., the social process guidance system 1200 provides suggested activities 1206 that would assist the user in adhering to the social media engagement strategy 1204.

The administrator 1202 can define multiple strategies, such as, for example increasing Facebook page engagements, or driving more hotel bookings.

The strategy directives 1206 indicate how the strategy should be achieved through system 200 activity. For example, posting selfless content to Facebook pages in a particular category, or creating posts that have links to post extender that contains links to a hotel booking engine.

The rules 1208 define how strategy directives 1206 are evaluated and goals are met by using a catalog of system data points. Such as, for example a particular rule could contain a count of selfless posts more than three in a particular post category or a count of posts with embedded links greater than five. Each of the rules 1208 can be modified and updated by the strategy administrator 1202 as the results are analyzed and the social media engagement strategy 1204 is modified.

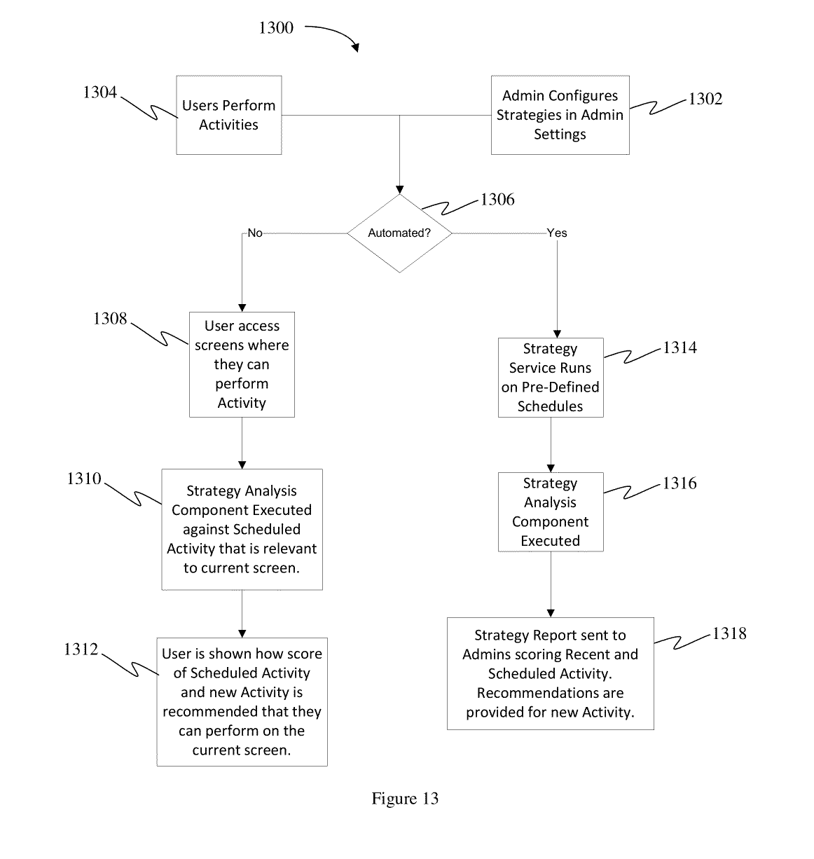

FIG. 13 is a detailed work flow diagram for social process guidance 1300 for the system of FIG. 12. As can be seen, an administrator configures strategies using administrator settings 1302. A user performs activities in the system 200. Then, a determination is made whether or not the process is automated 1306. If processes not automated, then, the user accesses screens where they can perform an activity 1308. Next, a strategy analysis component is executed 1310 against a scheduled activity that is relevant to the current screen where the user is performing the activity 1308. Then, the user is shown a score for their current scheduled activity and any new activities that are recommended for the user to perform are displayed on screen 1312. If the process is automated, then, a gamification service 1314 and a strategy analysis component 1316 are run on predefined schedules. The gamification service 1314 and the strategy analysis component 1316 are run a strategy report is sent to the administrator displaying recent and scheduled activity scoring 1318. Additionally recommendations are provided for new activities for users to perform.

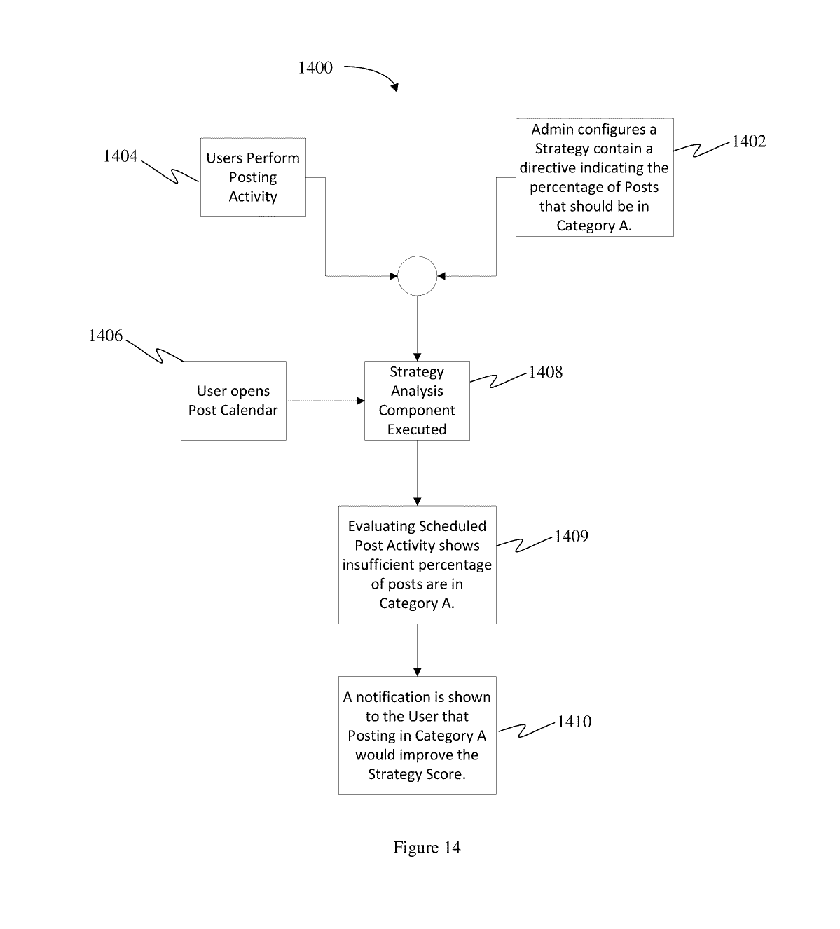

FIG. 14 is a work flow diagram for a post calendar 1400 useful for the system of FIG. 2. As can be seen, an administrator configures a strategy 1402 that contains a directive indicating the percentage of activities, such as, for example posts that should be in a particular category. A user performs the activity 1404 that was configured by the administrator 1402. When the user opens a post calendar 1406, a strategy analysis component 1408 is executed. The post activities for the user are evaluated 1409 to ascertain if the user is and adherence with the directive configured by the administrator 1402. A notification is displayed 1410 to the user identifying post categories that would improve the strategy score for the user.

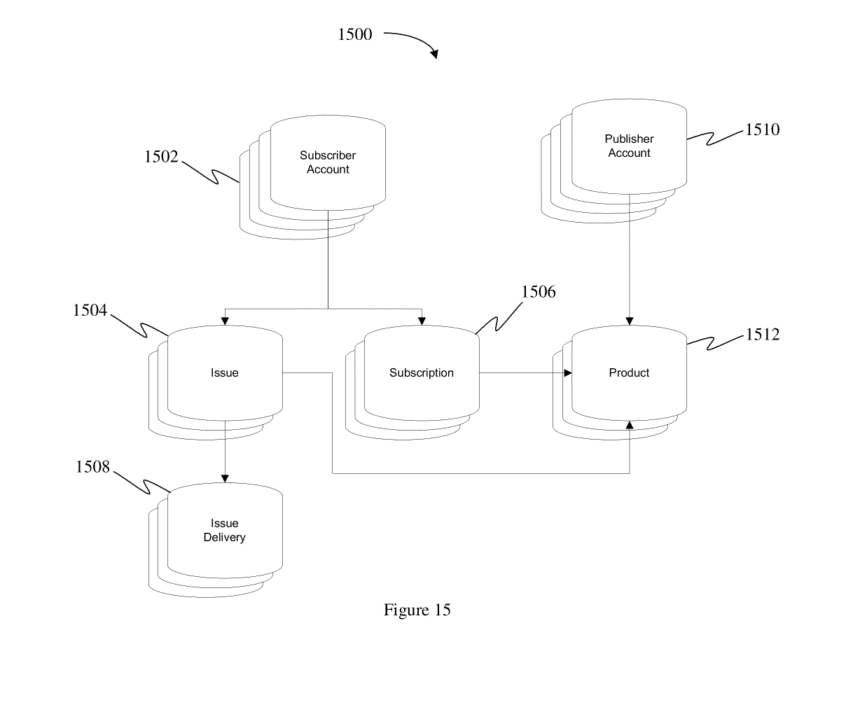

FIG. 15 is an entity diagram of a content store 1500 useful for the system of FIG. 2. As can be seen, the content store 1500 comprises subscriber account information 1502, issue information 1504, subscription information 1506, issue delivery information 1508, publisher account information 1510 and product information 1512. All information in the content store 1500 can be stored in a storage for retrieval and manipulation. The content store 1500 provides subscriber account information 1502 and publisher account information 1510 holders the ability to buy subscriptions to multiple pieces of content or single issues of content at a price set by content publishers that provide the content. The provided content may be free with billing handled by publishers directly, or may be billed by the system 200 then a portion of the fees can be remitted to the original publisher, stored in the publisher account information 1510, of the content. Subscriber account information 1502 can comprise multiple subscriptions to content. The subscriber account information 1502 also comprise one or more time periods for the delivery that the issues 1504 are to be delivered. Subscriber account information 1502 can also provide publisher accounts 1510 with proxy rights to social media profiles so that the publisher account 1510 holders can deliver suggested content to the subscriber account 1502. Each issue 1504 is delivered to the subscriber account 1502 or the publisher account 1510 as a suggested post. The issue 1504 can be delivered as a split post to supported social media profiles. Once an issue 1504 is delivered is a suggested post 1508 the delivery is recorded and the time that the issues posted for use in a content billing system. Products 1512 are subscriptions or individual issues that are provided by publisher account 1510 holders. Products 1512 define subscription periods, price per suggestion and price per post. Each product 1512 also stores the type of profile supported by the content, i.e. twitter, Facebook, log, forum, etc.

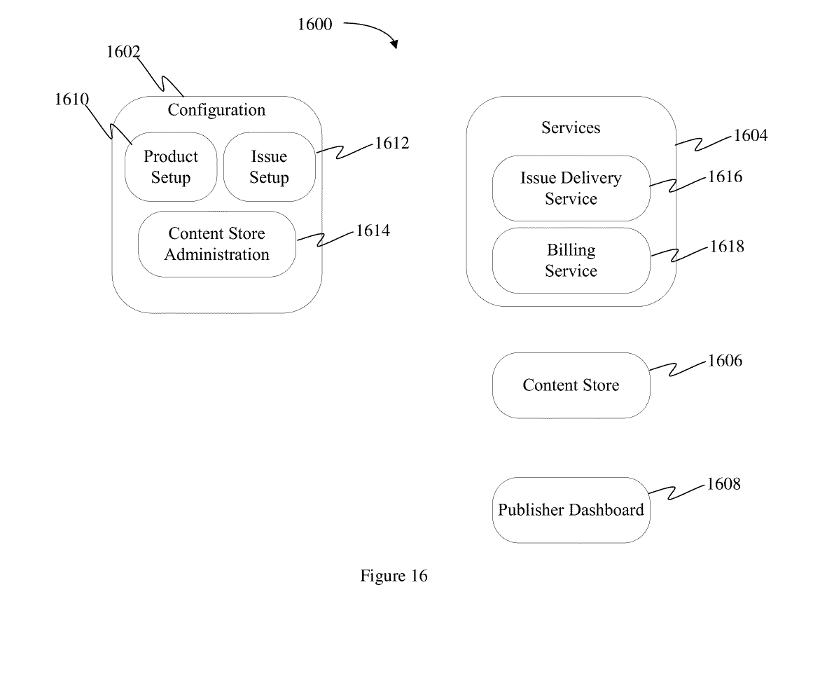

FIG. 16 is a diagram of a content store system 1600 useful for the system of FIG. 2. As can be seen, the system comprises a configuration module 1602 a services module 1604 a content store 1606 and a publisher dashboard 1608. The configuration module 1602 further comprises a product setup module 1610, an issue setup module 1612 and a content store administration module 614. Using the configuration module 1602, publisher accounts 1510 can set up the content to be provided to others using the product setup module 1610 and the issues setup module 1612 so that subscriber accounts 1502 can see the content available for subscription 1506. Using the content store administration module 1614 system administrators can manage the store by adding, deleting or modifying available products 1512 and issues 1504.

The services module 1604 further comprises an issue delivery service 1616 and a billing service 1618. Both the issue delivery service 1616 and the billing service 1618 are automated services that deliver issues 1504 for one-time purchases and subscriptions 1506 and then Bill the appropriate subscriber account 1502 accordingly using the billing services module 1618.

The content store 1606 provides subscription capabilities for subscriber account holders 1502 two purchase products order single issues, rate the content provided by the publisher account holders 1510 and submit requests for new types of content from publisher account holders 1510.

The publisher dashboard 1608 displays for publisher account holders 1510 results for the content that you publisher account holder 1510 provided to the system 1500. Publisher account holders 1510 can use the publisher dashboard 1608 two enter the configuration module 1602 and display performance analytics of subscriptions 1506 and issues 1504. The publisher dashboard 1608 also provides access to the billing services module 1618 so that the publisher account holders 1510 can view billing status for the content provided.

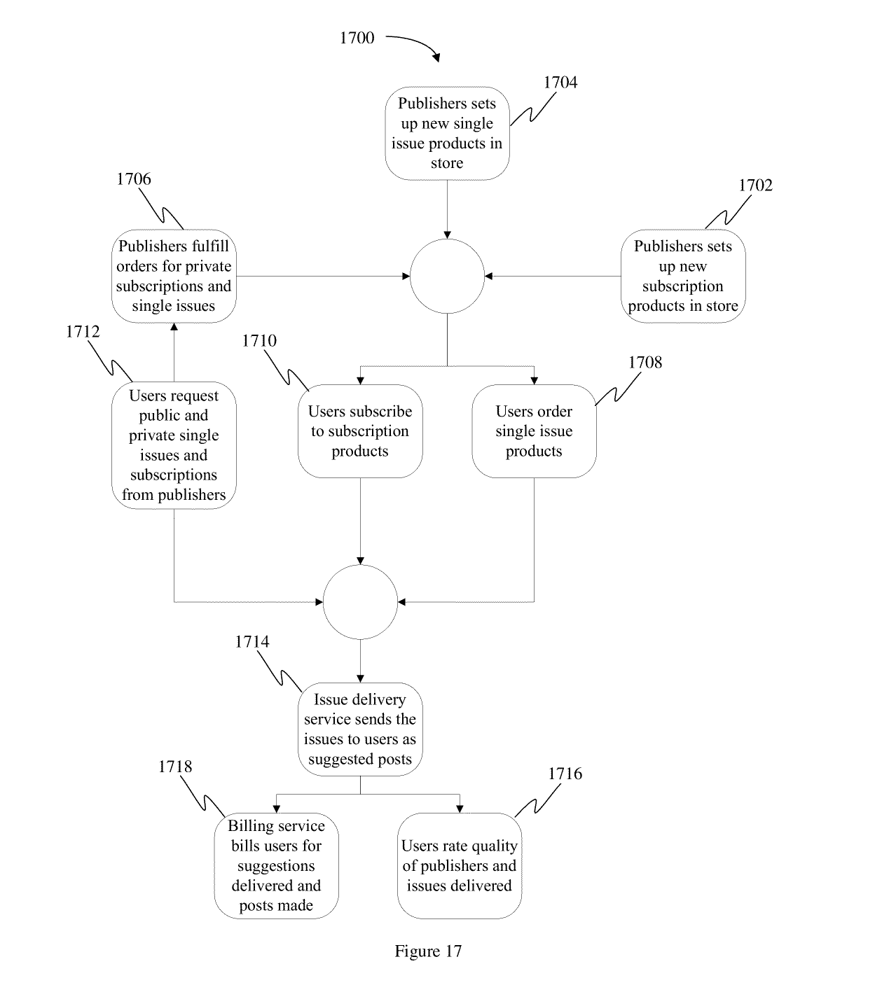

FIG. 17 is a workflow diagram of the content store system of FIG. 16. As can be seen, a publisher account holder 1510 can set up new subscription 1702 products, or fulfill orders for private subscriptions and single issues 1706 in the content store 1500. Then subscriber account holders 1502 can either subscribe 1710, order single issue products 1708 or request public and private single issues and subscriptions from publishers 1712 for fulfillment 1706. An issue delivery service sends either the subscribed products 1710 or the single issue products 1708 to the subscriber account holder 1502 as a suggested post 1714. Then, the billing service module 1618 bills the subscriber account holder 1502 four suggestions delivered and posts made 1718. Users provide feedback and rate the quality of the publisher's account 1510 and the issues delivered 1716.

The content store provides a vast arena for individual authors and others comfortable with writing for social media. This provides many small and medium-size businesses with the opportunity to purchase, or suggest content to be written applicable to their particular businesses or brands. In today's hectic world of all variety of demands and business owners for marketing and promoting their business, the present system eliminates one of the major distractions by making it easy for them to provide content and marketing to their clients, customers and potential customers.

For example, in a typical e-commerce store, such as, for example the Apple® app store, people or companies submit items for consumers to browse and purchase. However, in the social media space there are no places for content creators to submit content of any size for others to browse by topic, author, language, writing style, writing level or rating. Although there are many independent sites, or individual businesses that can provide content, there is no one single source for global content subscriptions and purchases. Currently everything is done by single contract among individuals and businesses. Advantageously, the present system will provide a forum for content creators globally to be able to meet the one basic need of all social media, new, fresh content on a regular basis.

The content will be stored in multiple forms such as, for example, text with no formatting, blog format ready to be copied and pasted, or social media channel specific formats ready to be posted or scheduled to be posted in an account holders 1502 account in the content store 1500. Account holders 1502 will be able to browse the content store 1500 and easily at the selected content to the account holders 1502 post calendar 1400 to be scheduled for submission to the selected social media sites. Also advantageously, account holders 1502 will now be able to browse and find content to share with their communities without fear of posting material that violates copyright and having their site shutdown. Also, original content creators now have a place to upload their articles and content to make money from their skills and building their reputation and followers.

What has been described is a new and improved system and method for a real-time social brand management system that provides a balanced approach to listening, posting and reporting, overcoming the limitations and disadvantages inherent in the related art.

Although the present invention has been described with a degree of particularity, it is understood that the present disclosure has been made by way of example. As various changes could be made in the above description without departing from the scope of the invention, it is intended that all matter contained in the above description or shown in the accompanying drawings shall be illustrative and not used in a limiting sense.

What is claimed is:

1. A method for a real-time social brand management system, the method comprising the steps of:
a) opening a post creation graphical user interface by a user;
b) creating one or more posts;
c) tagging the posts;
d) committing the posts;
e) scheduling one or more times to submit the posts to one or more social media services;
f) analyzing the posts submitted for effectiveness using metrics;
g) establishing one or more publishing strategy guidelines using the analysis of step f; and
h) reviewing scheduled and historical posts to drive content creation using the one or more publishing strategy guidelines.

2. The method of claim 1, where one or more post is a suggested post.

3. The method of claim 2, further comprising the step of submitting the suggested post to a suggested content list in a user account.

4. The method of claim 3, further comprising the step of reviewing the suggested content list to determine if the post should be archived or approved.

5. The method of claim 4, where if the post is to be archived, then the post is added to an archive queue.

6. The method of claim 5, further comprising the step of searching the archive by category at a date to be scheduled for resubmission.

7. The method of claim 1, where one or more post is a scheduled post.

8. The method of claim 7, further comprising the step of submitting the post to a scheduled queue in the user's account.

9. The method of claim 1, where the step of tagging can be done using a preset category, a user created category or a post type indicator.

10. The method of claim 1, further comprising the step of reviewing content submitted to various social media sites and replying, sharing or both replying and sharing the reviewed content.

11. The method of claim 1, where the metrics used can be a category tag.

12. A method for a system real-time social brand management system, the method comprising the steps of:
a) establishing rules for one or more listening, posting and reporting games by an administrator;
b) configuring games, where the games can be combined into contests, awards and designations;
c) promulgating the contests, games, awards and designations;
d) providing access to the contests, games, awards and designations for one or more contestants;
e) measuring contestants activity and scoring the one or more contestants results; and
f) awarding prizes, designations or both prizes and designations for activity ranked against peers.

13. The method of claim 12, where one or more contestants can enter one or more contests.

14. The method of claim 13, further comprising the step of weighting scores for each contestant against other contestants.

15. The method of claim 12, further comprising the step of providing awards to each contestant.

16. The method of claim 15, where the awards can be points.

17. The method of claim 15, where the awards are selected from the group consisting of vacation days, gifts, gift cards and bonuses.

18. The method of claim 12, further comprising the step of providing designations based on the contestants accumulating awards.

19. The method of claim 12, where the games can comprise rules and expressions that are evaluated.

20. The method of claim 12, further comprising the steps of:
a) inviting a second user of a second account to create a proxy account;
b) receiving and acceptance from the second user;
c) creating a proxy account for the second user;
d) adding the created proxy account for the 2nd user to a posting group; and
e) attaching social media profiles to the created proxy account.

21. The method of claim 20, further comprising the steps of:
a) selecting a posting group as the destination for a new post;
b) submitting the new post as a suggestion, where the post is submitted to the proxy accounts suggested content list;
c) submitting the new post as a scheduled post, where the new post is submitted to the proxy accounts scheduled queue;
d) approving the new post by the proxy user and scheduled for submission; and
e) submitting to a third-party social media system stored in the profile associated with the proxy account the new post.

22. The method of claim 20, wherein the step of inviting a second user is sent by e-mail.

23. The method of claim 20, wherein the step of receiving and acceptance is performed by selecting a link in a provided e-mail.

24. The method of claim 12, further comprising the steps of:
a) creating a post, where the post created can be a genome or a basic post;
b) selecting a social media services profile to submit the post;
c) submitting a non-split post to the selected social media services profiles;
d) copying the original post genome into a customizable content area for the selected profile;
e) modifying the copied post genome based on demographics stored in the social media services profiles and limits and special features of any selected channel;
f) committing the post as a suggestion, where the post is submitted to the user's account suggested content list;
g) committing the post as a scheduled post, where, the post is submitted to the users account scheduled queue;
h) approving and scheduling the post by an administrator for submission; and
i) submitting the profile specific content using a post service to the selected social media services at a scheduled time.

25. The method of claim 12, further comprising the steps of:
a) creating a post, where the post created can be a genome;
b) shortening a uniform resource locator for insertion into the post;
c) inserting a templated shortened uniform resource locator into the post content;
d) selecting the social media profiles proposed for submission;
e) committing the post as a suggestion, where the post is submitted to the user's account suggested content list for approval;
f) committing the post as a scheduled post, where the post is submitted to the user's account scheduled queue;
g) submitting the post using a post service to selected social media services, and replacing the templated shortened uniform resource locator with a channel indicator at a scheduled time;
h) receiving a selection indicator from an external user on the social media service;
i) interpreting and recording the received link as coming from the original channel; and
j) redirecting the received link to the intended uniform resource locator containing the post.

26. A method for a real-time social brand management system, the method comprising the steps of:
a) configuring games, where the games can comprise rules, contests and awards for gamification;
b) performing activities;
c) determining if activity processing is to be automatic;

27. The method of claim 26 further comprising the steps of:
a) manually accessing gamification results;
b) manually executing a contest component;
c) manually executing an award component; and
d) displaying awards and achievement results to a user accessing the system.

28. The method of claim 26 further comprising the steps of:
a) automatically executing a gamification service on a predefined schedule;
b) automatically executing a contest component on a predefined schedule; and
c) automatically executing an award component on a predefined schedule.

29. The method of claim 28, where when the contest component is executed, contest summary e-mails are sent to all contestants.

30. The method of claim 28, where when the award component is executed, award and achievement notices are sent by e-mail to winning contestants.

31. A method for a system real-time social brand management system, the method comprising the steps of:
a) determining one or more than one social media engagement strategy by posting, listening and connecting with social media users;
b) configuring the social media engagement strategy by an administrator;
c) evaluating the social media users activities against the activities adherence to the defined social media engagement strategy,
where the evaluation is calculated using scores, posts, scheduled activities and established rules as criteria; and
d) providing suggested activities to assist the social media user in adhering to the social media strategy.

32. The method of claim 31 further comprising the steps of:
a) performing activities by a user;
b) executing a strategy analysis component against a scheduled activity that is relevant to the activity being performed;
c) scoring the scheduled activity; and
d) providing new activities for the user to perform.

33. A method for a real-time social brand management system, the method comprising the steps of:
a) providing a post calendar;
b) configuring a strategy containing a directive indicating the percentage of activities by an administrator;
c) performing the activity configured by the administrator;
d) opening the post calendar;
e) executing a strategy analysis component when the post calendar is opened;
f) evaluating the post activity using a criteria to ascertain if the user is and adherence with the directive configured by the administrator; and
g) displaying a notification to the user identifying post categories that would improve the strategy score for the user.

34. A method for a real-time social brand management system to qualify and reward user activity, the method comprising the steps of:
a) providing a content store where the content store comprises:
1) subscriber account information;
2) issue information;
3) subscription information;
4) issue delivery information;
5) publisher account information; and
6) product information.
b) providing subscription purchase options for one or more pieces of content at a price set a content publishers that provides content;
c) billing for purchased subscriptions;
d) delivering purchased subscriptions.

35. The method of claim 34, where the purchase subscriptions are delivered at one or more time periods stored in the content store.

36. The method of claim 34, where the subscriber accounts provide publisher accounts with proxy rights to social media profiles so that the publisher account can deliver suggested content to the subscriber account.

37. The method of claim 34, where the subscriber account, the publisher account or both the subscriber account and the publisher account issues can be delivered as a split post to one or more supported social media profiles.

38. The method of claim 34, where the products information comprises storing a subscription period, a price per suggestion and a price per post.

39. The method of claim 38, where the products information comprises storing one or more social media profile supported by the content.

40. The method of claim 34 further comprising the steps of:
a) providing instructions for a configuration module;
b) providing instructions for a services module;
c) providing instructions for a content store; and
d) providing instructions for a publisher dashboard.

41. The method of claim 40 where the instructions for the configuration module further comprise instructions for:
a) a product setup module;
b) an issue setup module; and
c) a content store administration module.

42. The method of claim 40 where the instructions for the services module further comprise instructions for:
a) an automated issue delivery service; and
b) an automated billing service.

43. A real-time social brand management system that provides a balanced approach to listening, posting and reporting comprising:
a) a non-transitory computer readable storage medium comprising executable instructions to configure a computer to perform a method comprising the steps of:
1) opening a post creation graphical user interface by a user;
2) creating one or more posts;
3) tagging the posts;
4) committing the posts;
5) scheduling one or more timed to submit the posts to one or more social media services;
6) analyzing all the posts submitted for effectiveness using metrics;
7) establishing one or more publishing strategy guidelines using the analysis; and
8) reviewing scheduled and historical posts to drive content creation using the one or more publishing strategy guidelines.

44. The system of claim 26, further comprising instructions for a configuration module for configuring the system.

45. The system of claim 44, further comprising instructions for:
a) a game setup module operably connected to the configuration module;
b) a contest setup module operably connected to the configuration module;
c) a rules setup module operably connected to the configuration module;
d) an award setup module operably connected to the configuration module;
e) a designation set up mode operably connected to the configuration module;
f) a services module operably connected to the configuration module, where the services module comprises instruction for a contest service module and an award service module;
g) an award fulfillment module operably connected to the configuration module;
h) a leaderboard operably connected to the configuration module; and
i) an account information store operably connected to the configuration module, where the instructions for the account information store comprise account information and one or more than one social media profile and one or more than one user associated with the account.

46. The system of claim 45, where the information for each user associated with the account further comprises unique credentials to access the system and for tracking.

47. The system of claim 44, further comprising computer instructions for configuring a proxy account and a non-proxy account, where the proxy account comprises one or more than one different social media profiles than the non-proxy account.
